(19) United States
(12) Patent Application Publication
(10) Pub. No.: US 2018/0349558 A1
(43) Pub. Date: Dec. 6, 2018

(54) SYSTEMS AND METHODS FOR AUTONOMOUS DISCHARGE QUEUE MANAGEMENT

(71) Applicant: CERNER INNOVATION, INC., Kansas City, KS (US)

(72) Inventors: Revathi Sankar, Chennai (IN); Deepika Roy, Bangalore (IN); Soumen Tapadar, Bengaluru (IN)

(21) Appl. No.: 15/614,281

(22) Filed: Jun. 5, 2017

(51) Int. Cl. G06F 19/00

(52) U.S. Cl. CPC G06F 19/327; G06F 19/322

(57) ABSTRACT

Methods, systems, and computer-readable media are provided for computer-based autonomous discharge queue management. Individuals having been admitted to a medical facility such as an emergency department are autonomously screened and prioritized for discharge. The screening can be performed based on one or more screening criteria including a determination of whether an individual's vital signs have stabilized. The prioritization can be performed based on one or more prioritization criteria. In exemplary embodiments, the prioritization criteria include length of stay, disability status and age. The resulting prioritized discharge queue, a portion thereof, or some other indication of discharge priority based thereon can be provided to one or more caregiver devices in the medical facility to assist with discharging individuals in a quick and efficient manner.

### BACKGROUND

Many medical facilities such as hospitals or other primary care centers include departments that practice emergency medicine. Individuals seeking emergency treatment from an emergency department generally visit the emergency department without an appointment. Medical professionals triage these individuals, prioritizing the individuals for care based on clinical need upon arrival. Depending on clinical need, such individuals may be treated immediately, transferred to other departments or admitted for treatment in the emergency department. Some individuals may be discharged after treatment, while others may be held for continued treatment or observation. These individuals are discharged once a medical professional determines that it is safe to do so.

### SUMMARY

Embodiments of the present invention provide methods and systems for implementing autonomous discharge queue management. Such systems and methods represent a new paradigm to facilitate the process of discharging individuals from an emergency department with an eye toward reducing individual length of stay. In general, once individuals have been admitted and treated, their vital signs are monitored, for example, continuously. The disclosed algorithm autonomously screens admitted individuals to determine whether treated individuals have vital signs that are stable, and autonomously prioritizes these individuals for discharge based on criteria including the individual's length of stay, disability status and age. An indication of discharge priority is provided to the care team, indicating the prioritized queue of individuals ready to be discharged, or some portion thereof. In this manner, the disclosed system and method facilitates efficient and quick discharge.

At a high level, a system for implementing autonomous discharge queue management includes a hardware processor and memory. The hardware processor is configured to perform a predefined set of basic operations in response to receiving a corresponding basic instruction selected from a predefined native instruction set of codes. The system includes a a queue manager component which in turn includes a screening component and a prioritization component. The screening component includes sets of machine codes selected from the native instruction set and configured to access a first data structure comprising admitted individuals having been admitted for a visit to an emergency department of a medical facility, determine, from the admitted individuals, retained individuals that have not been discharged from the emergency department, access electronic medical records for the retained individuals to determine individuals with recorded vital signs having been recorded more than once, and determine eligible individuals by determining a vital sign stability. The prioritization component includes sets of machine codes selected from the native instruction set and configured to sort eligible individuals based on length of stay, resolve sorting conflicts by designating a first resolution priority based on disability and by designating a second resolution priority based on age, initialize and populate one or more second data structures comprising a prioritized discharge queue of eligible individuals, and generate an indication of discharge priority based on the prioritized discharge queue for delivery to at least one caregiver device in the emergency department. The queue manager component includes a set of machine codes selected from the native instruction set and configured to operate the screening and prioritization components to continuously update the prioritized discharge queue.

### BRIEF DESCRIPTION OF THE DRAWINGS

Embodiments are described in detail below with reference to the attached drawing figures, wherein:

FIG. 1 is a block diagram of an exemplary autonomous discharge queue management system, in accordance with embodiments described herein;

FIG. 2 is a flow diagram showing an exemplary method for providing an autonomous discharge queue management system, in accordance with embodiments described herein;

FIGS. 3A and 3B depict an exemplary user interface displaying non-prioritized individuals (FIG. 3A) and prioritized individuals for discharge (FIG. 3B), in accordance with embodiments described herein;

FIG. 4 is a flow diagram showing an exemplary method for providing an autonomous discharge queue management system, in accordance with embodiments described herein;

FIG. 5 is a block diagram of an exemplary computing environment suitable for use in implementing embodiments described herein.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In the emergency department (ED), every minute is crucial. As a result, streamlining the flow of individuals through the ED can be considered as important as initiating the appropriate treatment for an individual. Conventional methods for discharging individuals from an ED have several shortcomings. For example, although individuals are prioritized for treatment (triaging), the average length of stay (LOS) for the individual in the ED is still subject to improvement. More specifically, conventional discharge methods involve significant human intervention, which can be time consuming, inefficient, and susceptible to human error. Accordingly, there is often a significant delay between an individual being identified for discharge until the individual is actually discharged. Discharge delays in turn can impact the throughput of the medical facility operating or otherwise responsible for the ED. Such delays can also negatively impact individual satisfaction, medical facility capacity and financial performance. Other variations and combinations of shortcomings exist with conventional methods for discharging individuals from a medical facility such as an emergency department of a hospital. As such, processes to support autonomous discharge queue management are integral to the efficient discharge of individuals from medical facilities.

Accordingly, embodiments of the present invention are directed to methods, systems, and computer-readable media for a system and method for implementing autonomous discharge queue management. More specifically, an autonomous discharge queue management system implements the concept of triaging to the discharge process. Vital signs for admitted individuals are monitored (e.g., continuously) to determine whether the vital signs conform to an acceptable range. The individuals whose vital signs are stable are sorted, and a discharge priority can be presented to a medical provider in the ED to assist in prioritizing individuals determined to be ready for discharge. For example, a visual indicator can be provided indicating that a particular individual's vital signs are stable and that the individual is ready to be discharged. When there are many individuals who are all ready for discharge at the same time, the autonomous discharge queue management system can provide a prioritized discharge queue or other indication of discharge priority to one or more caregiver devices. These indications of discharge priority can assist the care team to prioritize these individuals for efficient and quick discharge.

At a high level, the autonomous discharge queue management system supports a mechanism for a care provider (e.g., a hospital, an ED, etc.) to provide medical care professionals with an indication of discharge priority for individuals eligible for discharge. In general, the autonomous discharge queue management system accesses an electronic list of individuals who have been admitted to a medical facility such as an ED. The list of admitted individuals is generally stored in one or more suitable data structures (for example, a linear data structure such as an array, a list, etc.). Data structures are known in the art and various suitable data structures are contemplated within the present disclosure. The autonomous discharge queue management system filters out admitted individuals with an associated discharge date and time and/or with a discharge order placed for the current visit, for example, by inspecting one or more corresponding variables (e.g., a flag) indicating a discharge status.

Electronic medical and/or health records for these admitted and not discharged, individuals can be accessed to determine whether their vital signs have been sampled and recorded more than once. Vital signs can include body temperature, pulse rate, and respiration rate (rate of breathing). In some embodiments, vital signs can include blood pressure. Recorded vital signs can be analyzed to determine a measure of stability. For example, the latest sample of an individual's vital signs can be compared with a defined reference range. Individuals having vital signs within the defined reference range may be autonomously determined to be eligible for discharge. In some embodiments, individuals are only determined to be eligible for discharge when their vital signs have stabilized (e.g., fall within a defined reference range) for a specified duration (e.g., an hour). Various other techniques, algorithms and heuristics for determining stabilization are contemplated within the present disclosure. In embodiments disclosed herein, individuals whose vital signs are not stable are generally not eligible for discharge because these individuals may require additional treatment from a medical professional who may seek to admit these patients into inpatient/ICU.

The autonomous discharge queue management system can autonomously prioritize discharge-eligible individuals based on various prioritization factors such as length of stay (LOS), disability and age. LOS can be considered an important metric from billing and individual satisfaction perspectives. Accordingly, in preferred embodiments, eligible individuals may be sorted first by LOS, prioritizing individuals with a longer length of stay for earlier discharge. LOS can be tracked and/or filtered using varying degrees of precision. For example, LOS can be tracked and/or filtered by days, hours or minutes. Alternately and/or additionally, eligible individuals can be sorted based on one or more thresholds (e.g., average LOS of all eligible individuals in the ED, historical LOS for the ED or network of EDs, target LOS, etc.), and eligible individuals can be given tiered priorities (e.g., individuals whose LOS in the ED exceeds a threshold can be given first priority, followed by individuals with LOS equal to average LOS, followed by the set of individuals having LOS less than average LOS). This LOS prioritization can help reduce the LOS of individuals in the unit, thus improving the ED throughput.

Alternately and/or additionally, eligible individuals may be sorted based on disability and/or age, for example, to improve satisfaction of admitted individuals. In preferred embodiments, these criteria can be prioritized after length of stay. For example, after eligible individuals have been sorted by LOS, disability and/or age can be used to resolve sorting conflicts. More specifically, if one or more eligible individuals has the same LOS or a same prioritization based on a tiered LOS sorting, sorting conflicts can be resolved by prioritizing individuals with a disability and/or pediatric and geriatric individuals. For example, in preferred embodiments, a first resolution priority may be given to individuals with a disability and a second resolution priority may be given to pediatric and geriatric individuals. Remaining conflicts can be resolved, for example, by prioritizing individuals based on age (e.g., ascending or descending order).

Prioritization criteria can be stored locally and/or remotely using any number of data structures. In an exemplary embodiment, an individual's LOS for a given visit may be stored as a variable and monitored in the same computing device that performs the prioritization. Similarly, disability and age criteria may be stored as a variable in association with an electronic medical and/or health record stored and accessed from a remote data store. Of course, other configurations are contemplated and fall within the present disclosure.

This prioritization autonomously produces a prioritized queue of individuals eligible for discharge. The autonomous discharge queue management system can initialize and populate one or more data structures with the prioritized discharge queue and provide an indication of discharge priority to one or more caregiver devices in the medical facility (e.g., the ED). For example, the prioritized discharge queue (or aspects of the queue such as an indication of the first one or more individuals in the queue) may be provided to, or made accessible from, a display device such as a monitor, tablet, smart phone or the like. Of course, the indication of discharge priority is not limited to such visual indicators. For example, an auditory indication (e.g., an alarm, pre-recorded message, text-to-voice, etc.) and/or mechanical indication (e.g., cutaneous, kinesthetic, haptic sensations) may be generated from one or more caregiver devices in the medical facility (e.g., the ED). Generally, the discharge priority queue is periodically (e.g., continuously, nearly continuously or occasionally, whether or not in regular intervals) updated, and indications of discharge priority may be provided, by way of nonlimiting example, periodically, as changes become available, on-demand, or based on the occurrence of one or more events (e.g., a pre-programmed event such as an LOS threshold crossing).

As such, autonomous discharge queue management can be achieved based on autonomous screening to determine discharge eligibility and autonomous prioritization based on prioritization criteria. Accordingly, the autonomous discharge queue management system can prioritize and plan for hassle-free discharge of individuals from a medical facility such as a hospital or other primary care center, which may include an emergency department. In preferred embodiments, the autonomous discharge queue management system optimizes the workflow in emergency departments and improves hospital throughout and individual satisfaction. In this regard, the autonomous discharge queue management system reduces the length of stay of individuals who have stabilized, reducing the financial burden on the responsible medical facility and the individual.

The claimed solution is necessarily rooted in computerized medical technology in order to overcome a problem specifically arising in the realm of medical information networks. For example, as medical information systems have migrated to electronic environments, inefficient access to relevant electronic medical and/or health records has produced suboptimal discharge processes in computerized medical facilities. Conventional discharge methods involve significant human intervention, which can be time consuming, inefficient, and susceptible to human error. The claimed invention overcomes the limitations of current medical information networks accessible in computerized medical facilities, for example, by utilizing autonomous and instant access to an individual's electronic medical and/or health records, thereby rendering the discharge process more efficient, user friendly and cost-effective. Observers will notice improved performance, for example, based on the autonomously generated indications of discharge priority disclosed herein. Such features will reduce the number of “clicks” or entries a computer user has to make and results in reducing the memory utilization, CPU cycles, number of operations that need to be performed by the computer, and power consumption. The resulting cost savings and operational efficiencies of the autonomous discharge queue management system magnify the potential benefits of this technology.

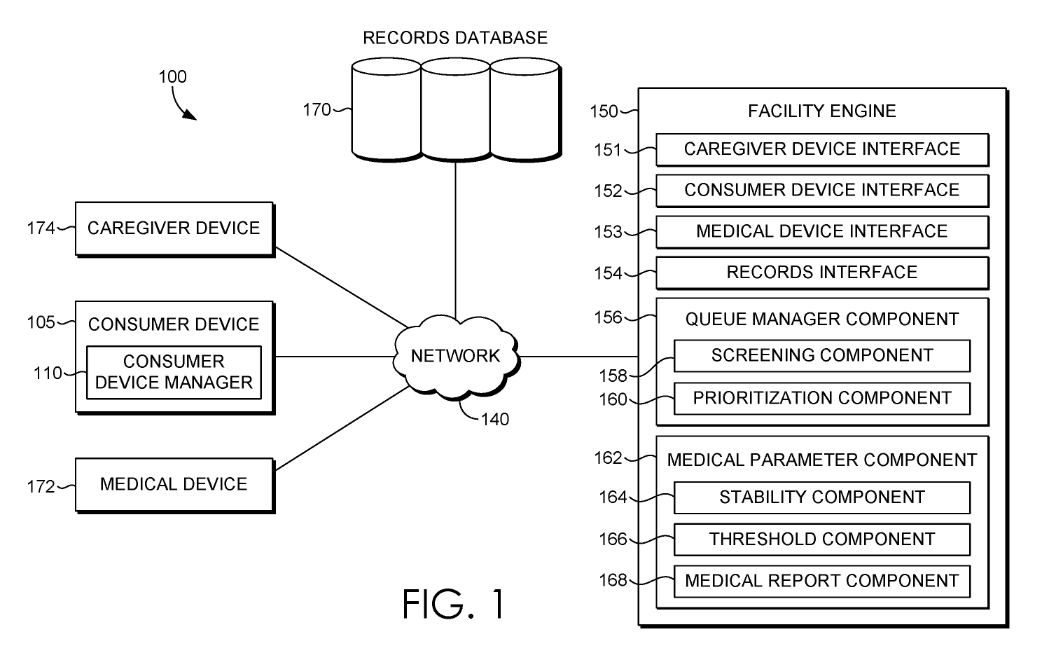

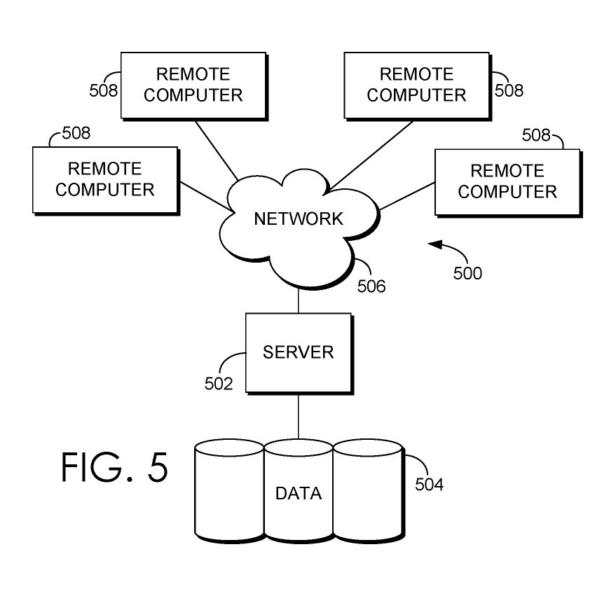

With reference to FIG. 1, embodiments of the present disclosure can be discussed with reference to an exemplary computing environment such as the one illustrated in FIG. 5 and explained in more detail below that serves as an operating environment for implementing the functionality described herein with respect to autonomous discharge queue management system 100.

FIG. 1 depicts exemplary autonomous discharge queue management system 100. Autonomous discharge queue management system 100 includes facility engine 150, network 140, records database 170, caregiver device 174, consumer device 105 and medical device 172. In the embodiment exhibited by FIG. 1, the processing duties may but need not be split among several computing systems and/or devices, each comprising one or more processors. By way of nonlimiting example, autonomous discharge queue management system 100 can distribute processing duties among facility engine 150, consumer device 105, caregiver device 174 and medical device 172. The tasks performed by the components of autonomous discharge queue management system 100 utilize a variety of computer and/or networking technology. In one embodiment, the technology can be divided into three tiers, web server, application server and database server, each tier comprising multiple layers, as can be understood a person of ordinary skill in the art having the benefits of the present disclosure. Records database 170 may be implemented through a database system and may comprise electronic medical records and/or electronic health records. Network 140, such as the internet or other public or private network, serves as a communications link for the components of autonomous discharge queue management system 100.

Facility engine 150 includes caregiver device interface 151, consumer device interface 152, medical device interface 153, records interface 154, queue manager component 156 and medical parameter component 162. It will be appreciated that some or all of the modules of facility engine 150 may be accessed via network 140 and could reside in whole or in part on one or more remote devices, such as caregiver device 174, consumer device 105 and/or medical device 172. Generally, facility engine 150 is a workflow management tool that can assist medical professionals in managing the flow of individuals through a medical facility such as an emergency department. Facility engine 150 generally screens and prioritizes eligible individuals for discharge and communicates an indication of discharge priority, for example, to one or more of caregiver device 174, consumer device 105 and/or medical device 172. Facility engine 150 provides a prioritized discharge queue to medical professionals treating individuals in the medical facility. Facility engine 150 maintains a real-time interface with the individual's records, treating medical professionals, medical devices associated with the individual and the individual's consumer device to track the medical parameter values for the individual.

In the embodiment depicted in FIG. 1, queue manager component 156 of facility engine 150 includes screening component 158 and prioritization component 160. Screening component 158 generally screens admitted individuals to determine individuals eligible for discharge based on one or more screening criteria. In preferred embodiments, screening criteria include a measure of vital sign stability. More specifically, screening component 158 accesses a data structure comprising a list of individuals having been admitted to a medical facility or department of interest such as an emergency room. The list of admitted individuals may be stored in memory located in facility engine 150, records database 170 (accessible via records interface 154), one of the other components depicted in autonomous discharge queue management system 100 (accessible via one of device interfaces 151, 152 or 153), elsewhere, or some combination thereof. From the list of admitted individuals, screening component 158 determines whether any of the admitted individuals have yet to be discharged. In some embodiments, determining whether individuals have yet to be discharged includes determining whether a discharge order has been signed. The determination may be based on a variable stored, for example, in the same or an associated data structure as the list of admitted individuals is stored. The result is a determination of admitted and not discharged individuals.

Screening component 158 can determine a measure of stability (such as vital sign stability) for admitted individuals. For example, screening component 158 can determine individuals with recorded vital signs having been recorded more than once. For example, when an individual is admitted, and periodically thereafter, a medical professional or medical device may take a sample of an individual's vital signs and store the sample in memory located in caregiver device 174, medical device 172, records database 170, facility engine 150, elsewhere or some combination thereof (e.g., via network 140). In some embodiments, one or more medical devices such as medical device 172 may periodically (e.g., continuously, nearly continuously or occasionally, whether or not in regular intervals) sample one or more vital signs, or receive such a sample (e.g., entered by a medical professional), and such sample may be stored (for example, in an electronic medical record) in memory in one or more components of autonomous discharge queue management system 100 (e.g., via network 140). In this regard, screening component can store and access vital sign samples and determine whether more than one sample has been recorded for a given individual.

In this scenario, screening component 158 can determine eligible individuals by determining a stability of recorded vital signs. In the embodiment depicted in FIG. 1, screening component 158 communicates with medical parameter component 162 to accomplish this. For example, medical parameter component 162 can make such a determination in response to a request from queue manager component 156 (e.g., screening component 158) and communicate the result to queue manager component 156 and screening component 158 (e.g., via stability component 164 and/or medical report component 168). Medical parameter component 162 and its subcomponents are discussed in more detail below. Although the embodiment illustrated in FIG. 1 depicts medical parameter component 162 as separate from queue manager component 156 and screening component 158, this need not be the case. Accordingly, in some embodiments, queue manager component 156 and/or screening component 158 may make the stability determination. In each of these scenarios (and regardless of the screening criteria), the result is a collection of individuals determined to be eligible for discharge.

Prioritization component 160 generally prioritizes eligible individuals based on one or more prioritization criteria. In an exemplary embodiment, prioritization criteria include length of stay (LOS), disability status and age. For example, prioritization component 160 may first prioritize by LOS, then disability status, then age. More specifically, prioritization component 160 can sort eligible individuals in order of descending length of stay (LOS). Where eligible individuals have the same LOS, prioritization component 160 can resolve sorting conflicts based on age & disability, for example. In one embodiment, this can be accomplished by prioritizing for discharge those individuals with a disability and then prioritizing pediatric/geriatric individuals. This creates four groups of reprioritized individuals. The first group (disabled+pediatric/geriatric) can be sorted in ascending order of age. The second (disabled+adult) can be sorted in descending order of age. The third group (non-disabled+pediatric/geriatric) can be sorted in ascending order of age. The fourth group (non-disabled+adult) can be sorted in descending order of age. It should be noted that the screening and prioritization described herein is merely exemplary, and various other techniques, algorithms and heuristics for screening and prioritization are contemplated within the present disclosure. After applying the one or more prioritization criteria, the result is a prioritized queue of individuals determined to be eligible for discharge.

Queue manager component 156 (e.g., prioritization component 160) can initialize and one or more second data structures and/or populate the desired data structure(s) with the prioritized discharge queue. Queue manager component 156 generally updates the queue by re-screening and/or re-prioritizing periodically (e.g., continuously, nearly continuously or occasionally, whether or not in regular intervals). At any time (such as when a new discharge priority queue is available), facility engine 150 (e.g., queue manager component 156, medical report component 168 of medical parameter component 162, etc.) can generate an indication of discharge priority, based on the prioritized discharge queue, for delivery (e.g., via one or more of device interfaces 151, 152 and 153) to a device in the facility of interest (e.g., the emergency department). For example, facility engine 150 may communicate or otherwise cause the prioritized discharge queue to display on a display device such as a caregiver computer, tablet or smart phone. Additionally and/or alternately, facility engine 150 may communicate or otherwise cause to display a subset of the prioritized discharge queue such as one or more individuals determined to have the highest discharge priority. In some embodiments, the indication of discharge priority may be a displayable indicator (e.g., text or graphic effects such as bolding, italicizing, underlining, highlighting, blinking, resizing, and the like) associated with an individual in the medical facility, such as on one or more medical devices monitoring the individual. Additionally and/or alternately, the indication of discharge priority can be auditory and/or mechanical. In this regard, the indication of discharge priority can be utilized by one or more medical professionals in the medical facility to assist in prioritizing individuals for discharge.

In the embodiment illustrated in FIG. 1, medical parameter component 162 includes stability component 164, threshold component 166 and medical report component 168. Medical parameter component (e.g., stability component 164) can determine whether a particular medical component of interest is stable. For example, queue manager component 156 can request stability component 164 determine whether a particular individual's vital signs are stable. In this scenario, stability component 164 accesses identified medical parameters (e.g., default parameters, vital signs being monitored using or more medical devices such as medical device 172, parameters identified via caregiver device 174, etc.) and locates any recorded samples (e.g., from the individual's current visit). Recorded samples can be accessed from memory located in one or more of the components of autonomous discharge queue management system 100 (e.g., via one or more of interfaces 151, 152, 153 and 154 of facility engine 150 and network 140). In some embodiments, stability component 164 can determine whether enough samples are present to make a stability determination (for example, more than one sample, samples corresponding to a unit of time such as the past hour, etc.).

Stability component 164 can determine a measure of vital sign stability. For example, stability component 164 may determine whether medical parameters of interest have remained in within a defined reference range and for a defined duration (e.g., default, entered via caregiver device 174, etc.). Stability component 164 can provide a notification of vital sign stability (e.g., via medical report component 168) to queue manager component 156 and/or one or more of caregiver device 174, consumer device 105 and medical device 172 (e.g., via corresponding caregiver device interface 151, consumer device interface 152 and medical device interface 153, and network 140).

In some embodiments, threshold component 166 can provide an indication of whether a medical parameter of interest has crossed a defined threshold. Defined threshold values may be numerical, existing/non-existing, positive or negative or text depending on the medical parameter. For example, threshold component 166 can provide an indication of a threshold event such as a threshold crossing for stability component 164. Alternately and/or additionally, threshold component 166 can provide an indication of a threshold crossing for other medical parameters, for example, those indicated by a medical parameter via caregiver device 174 and/or those being monitoring via medical device 172. In this regard, threshold component 166 can periodically sample an identified medical parameter, store the samples in memory such as records database 170 (via network 140) or memory local to facility engine 150, and compare the samples against a defined threshold. Threshold component 166 can provide a notification of a threshold crossing (e.g., via medical report component 168) to queue manager component 156 and/or one or more of caregiver device 174, consumer device 105 and medical device 172 (e.g., via corresponding caregiver device interface 151, consumer device interface 152 and medical device interface 153, and network 140).

In the embodiment depicted in FIG. 1, medical report component 168 issues health warnings and recommendations for an individual, for example, to a medical professional using caregiver device 174 (via caregiver device interface 151) and/or medical device 172 (via medical device interface 153), or to the individual using consumer device 105 (via consumer device interface 152 and consumer device manager 110). For example, medical report component 168 can provide an indication of vital sign stability, threshold crossing or other medical warnings and recommendations.

Generally, caregiver device interface 151 provides the interface with caregiver device 174 for facility engine 150. Caregiver device interface 151 can receive a selection of medical parameters and thresholds from caregiver device 174 and can communicate alerts and health recommendations for an individual and indications of discharge priority to caregiver device 174.

Medical device interface 153 provides the interface with medical device 172 for facility engine 150. Medical device interface 153 can receive samples of measurements of selected parameters from medical device 172 and can communicate alerts and health recommendations for an individual and indications of discharge priority to medical device 172.

Records interface 154 provides the interface with records database 170 for facility engine 150. Records interface 154 can access recorded samples of medical parameters (e.g., vital signs) and can provide sampled medical parameters and threshold crossing events to records database 170.

Consumer device interface 152 provides the interface with consumer device 105 for facility engine 150. Consumer device interface 152 is in communication with consumer device manager 110. Consumer manager 110 allows the individual to communicate with the individual's electronic medical records via network 140. The individual or the individual's representative may initiate registration of consumer device 105 via a web interface. The signup process will collect basic individual information such as individual identification and device identification numbers, a password and a unique user id which can be used to login. The individual identification number can be transmitted to records database 170, such that the correct electronic medical record for the individual is utilized. Consumer device interface 152 can communicate alerts and health recommendations to consumer manager 110 such that the information can be provided to the consumer via a user interface.

It will be appreciated that alerts and/or health maintenance plans can be communicated and displayed to medical professionals and/or individuals in a variety of ways including a message or message alert through an electronic medical record system such as Cerner Millennium, via e-mail or text message. Furthermore, the individual's electronic medical record is modified to reflect the alert and/or health maintenance plan.

Records database 170 is a computer store containing healthcare information for individuals. Records database 170 includes an electronic version of individual records, such as an electronic medical record (EMR), including information for the individual, such as medication and infusion orders, tasks, images, examination reports, testing and lab results, medical history, diagnosis, medical values etc. Records database 170 contains the standard medical and clinical data gathered in a provider's office. Records database 170 is a digital or computerized version of a paper chart that contains all of a patient's medical history. Individual identifier and device identifier numbers can be stored in the EMR for the individual.

Medical device 172 might include cardiac monitors, ventilators, balloon pumps, patient beds, infusion pumps, sequential-compression devices, electronic security devices, and vital-sign detecting devices, lab devices, medication administration devices, blood transfusion devices and any device that generates medical information for a patient. Medical device 172 may generate various data (e.g., measured heart rate) that, as described in more detail herein, can be communicated to facility engine 150.

Medical professionals may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, students, office assistants and the like. Caregiver device 174 can be a remote computer such as a personal computer, smart phone, personal digital assistant, server, router, network PC, peer device, other common network node, or the like, and may include some or all of the components described above in relation to the server. Caregiver device 174 may also be physically located in non-traditional medical care environments so that the entire health care community may be capable of integration on the network.

Having identified various components of the autonomous discharge queue management system, it is noted that any number of components may be employed to achieve the desired functionality within the scope of the present disclosure. The various components of FIG. 1 are shown with lines for the sake of clarity. Further, although some components of FIG. 1 are depicted as single components, the depictions are exemplary in nature and in number and are not to be construed as limiting for all implementations of the present disclosure. The autonomous discharge queue management system functionality can be further described based on the functionality and features of the above-listed components.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

### Exemplary Flow Diagrams

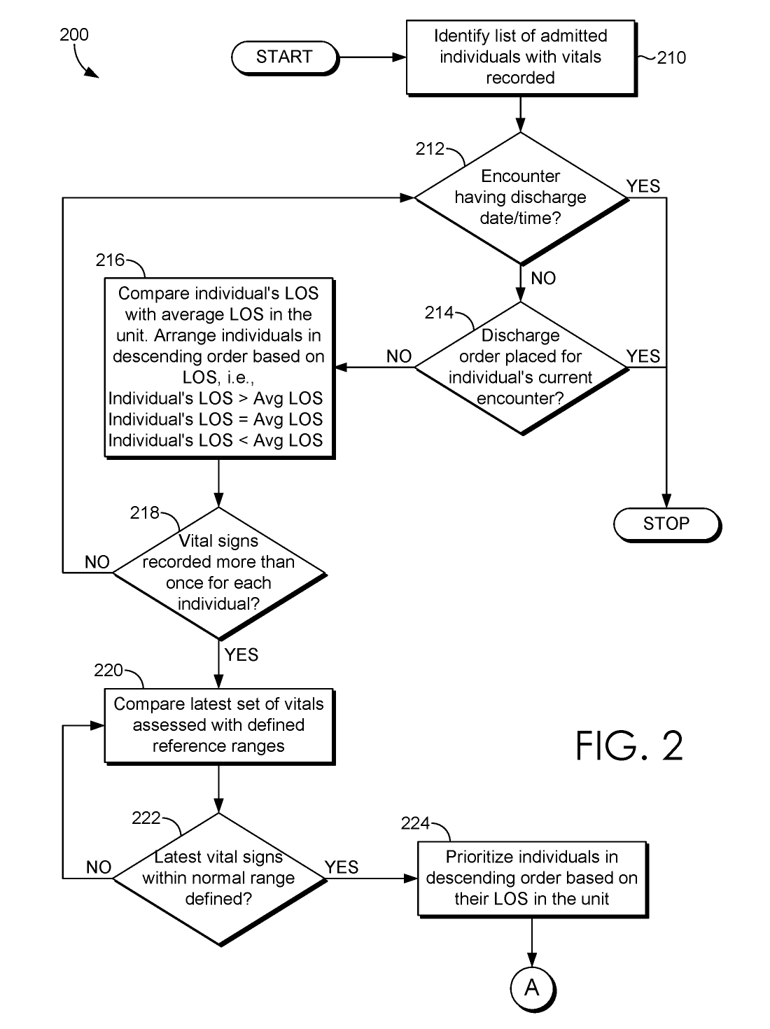

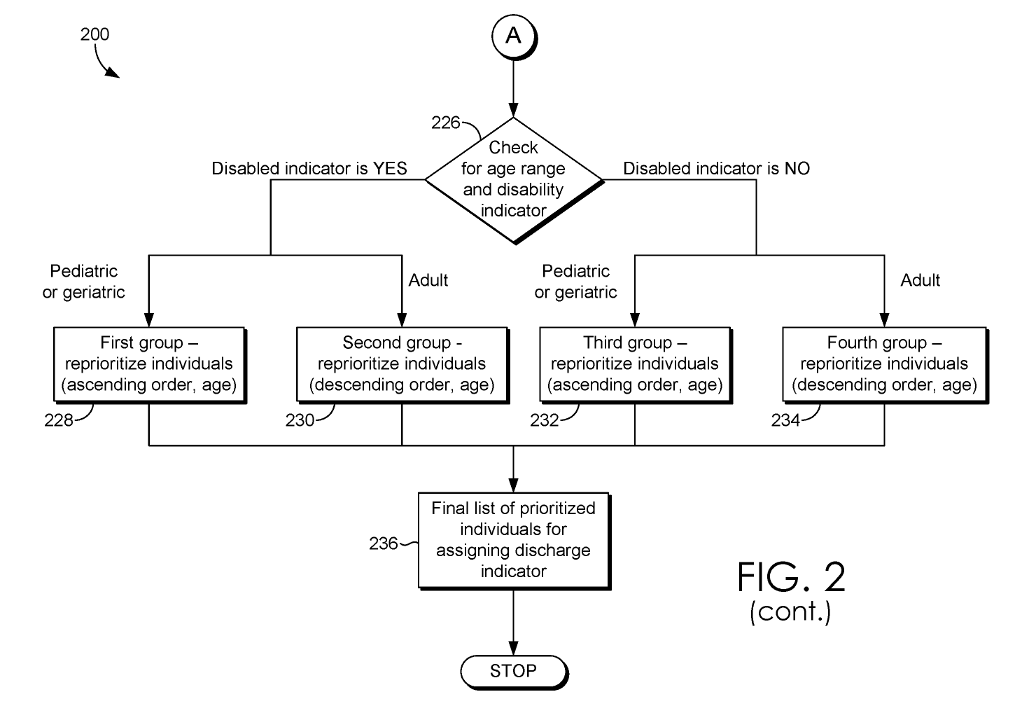

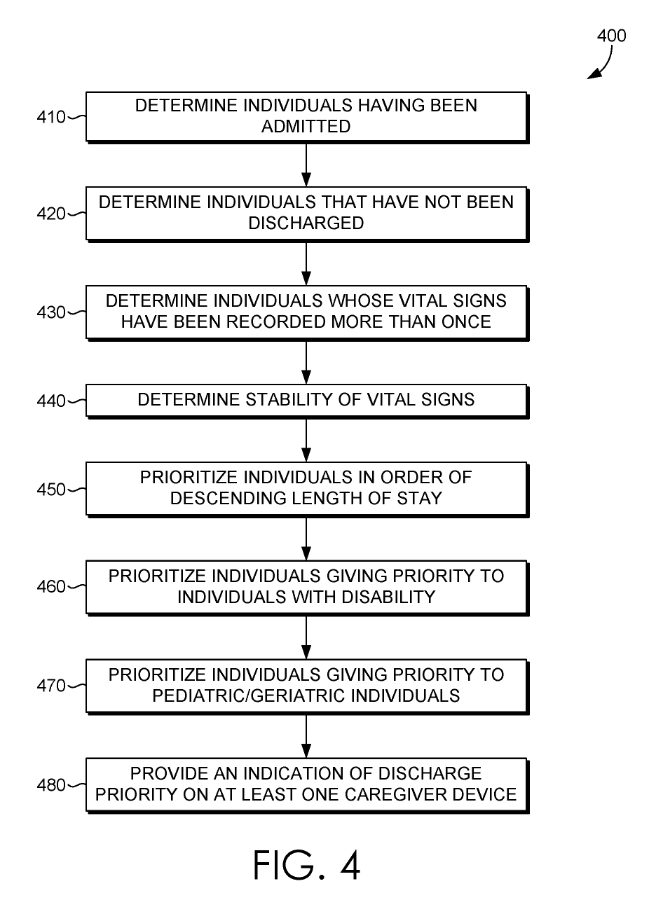

With reference to FIGS. 2 and 4, flow diagrams are provided illustrating methods for automatic and autonomous discharge queue screening and prioritization. The methods can be performed using the autonomous discharge queue management system described herein. In embodiments, one or more computer storage media have computer-executable instructions embodied thereon that, when executed, by one or more processors, can cause the one or more processors to perform the methods in the autonomous discharge queue management system.

Turning now to FIG. 2, a flow diagram is provided that illustrates a method 200 for providing autonomous discharge queue management. The method 200 can be performed using the autonomous discharge queue management system described herein. In particular, one or more computer storage media having computer-executable instructions embodied thereon that, when executed by one or more processors, can cause the one or more processors to perform the method 200.

At block 210, a list of individuals having been admitted to a medical facility such as an emergency department is identified. For example, it may be determined which individuals have an encounter identification number indicating a current visit, and have recorded vital signs indicating the intake process has occurred for that individual. It is determined whether the admitted individuals have a discharge date and time associated with the current encounter (block 212) and whether the admitted individuals have a discharge order placed for the current encounter (block 214). If either of these determinations is positive for an individual, that individual is filtered out of the screening. Individuals for which both determinations are negative are passed to block 216, where each individual's LOS is compared with the average LOS in the medical facility (e.g., ER), and the individuals are sorted based on this comparison, creating three tiers. The first tier consists of individuals whose LOS is above average, followed by the second tier consisting of individuals whose LOS is equal to average, and concluding with the third tier consisting of individuals whose LOS is below average. At block 218, it is determined whether each individual has had their vital signs recorded more than once. Patients for whom vitals have not been recorded more than once are filtered out and checked for discharge details at block 212.For those that have, their latest set of vital signs is compared with defined reference ranges at block 220. Individuals whose vital signs are not within normal range are passed back to block 220 for continued monitoring. Individuals whose vital signs are within normal range are deemed eligible and passed to block 224 for prioritization.

At block 224, eligible individuals are prioritized in descending order based on their LOS in the medical facility (e.g., emergency department). At block 226, each individual's age and disability status is determined, placing each individual in one of four categories. A first priority is given at block 228 to disabled pediatric or geriatric individuals, and this first group is reprioritized in ascending order of age. A second priority is given at block 230 to disabled adults, and this second group is reprioritized in descending order of age. A third priority is given at block 232 to non-disabled pediatric or geriatric individuals, and this third group is reprioritized in ascending order of age. A fourth priority is given at block 234 to non-disabled adults, and this fourth group is reprioritized in descending order of age. The result at block 236 is a prioritized queue of individuals eligible for discharge. The queue, portions of the queue, or other associated indications can be provided to a medical professional to assist with prioritizing individuals for discharge.

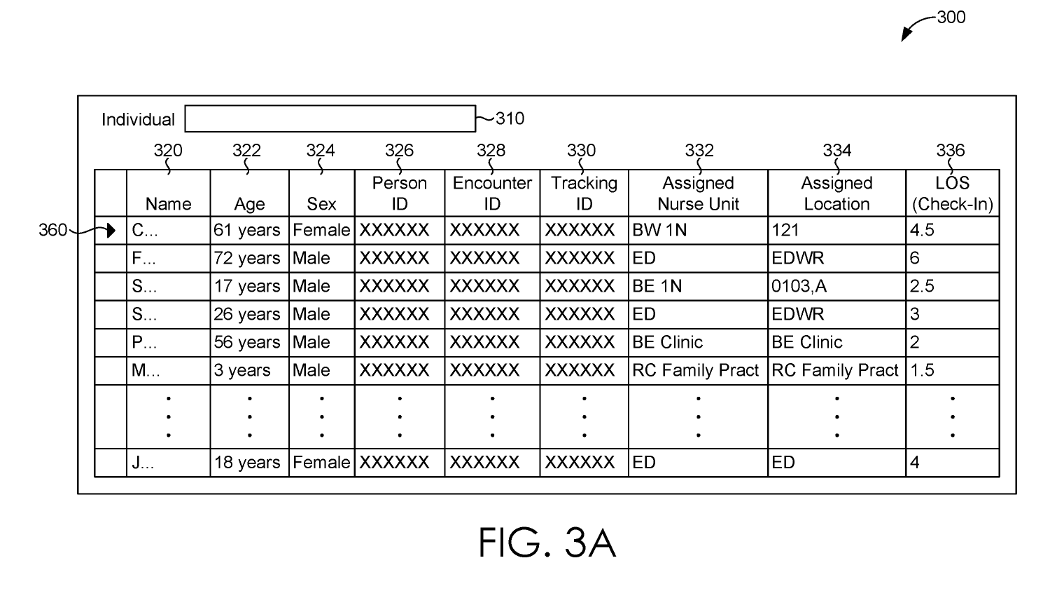

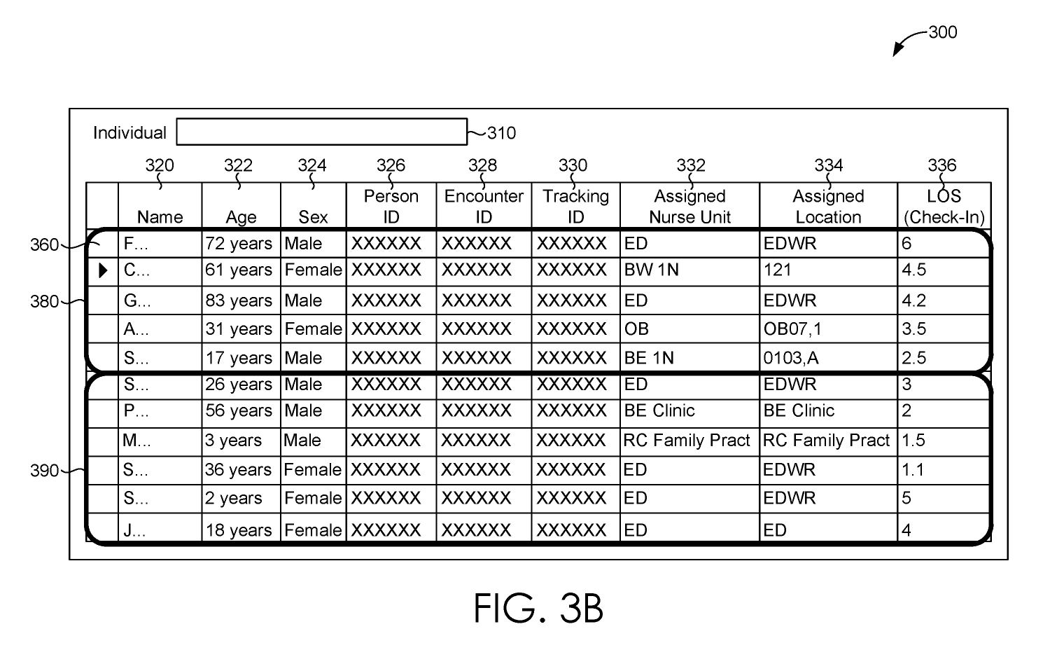

FIGS. 3A and 3B illustrate an exemplary user interface in accordance with some embodiments. Generally, user interface 300 can be provided to a caregiver device in a medical facility (e.g., emergency department) and provides information relating to admitted individuals. FIG. 3A depicts non-prioritized individuals and FIG. 3B depicts prioritized individuals. In the embodiment illustrated in FIGS. 3A and 3B, user interface 300 includes a table that includes admitted individuals, one per row. The table columns display exemplary information associated with each individual, including name 320, age 322, sex 324, person ID 326, encounter ID 328, tracking ID 330, assigned nursing unit 332, assigned location 334, and LOS 336 (hours). An individual may be selected, as indicated by indication arrow 360 and the individual's name being displayed in field 310. In FIG. 3A, the individuals have not been screened or prioritized. In FIG. 3B, individuals who have been screened and prioritized appear in queue 380, while those individuals who were deemed ineligible appear in portion 390.

Turning now to FIG. 4, a flow diagram is provided that illustrates a method 400 for providing autonomous discharge queue management. The method 400 can be performed using the autonomous discharge queue management system described herein. In particular, one or more computer storage media having computer-executable instructions embodied thereon that, when executed by one or more processors, can cause the one or more processors to perform the method 400. At block 410, individuals having been admitted to a medical facility (e.g., an emergency department) are determined. At block 420, it is determined which admitted individuals have not yet been discharged. Electronic medical records are autonomously accessed at block 430 to determine individuals whose vital signs have been recorded more than once. For these individuals, at block 440 it is determined whether their vital signs are stable. These eligible individuals are prioritized in order of descending length of stay (block 450), disability status (block 460) and pediatric/geriatric status (block 470). The resulting prioritized discharge queue can be used to provide to an indication of discharge priority to at least one caregiver device, for example, in a medical facility (e.g., an emergency department).

### Exemplary Computing Environment

An exemplary computing environment suitable for use in implementing embodiments of the present invention is described below. FIG. 5 is an exemplary computing environment (e.g., a medical-information computing-system environment) with which embodiments of the present invention may be implemented. The computing environment is illustrated and designated generally as reference numeral 500. Computing environment 500 is merely an example of one suitable computing environment and is not intended to suggest any limitation as to the scope of use or functionality of the invention. Neither should computing environment 500 be interpreted as having any dependency or requirement relating to any single component or combination of components illustrated therein.

The present invention is a special computing system that can leverage well-known computing system environments or configurations. A system, as used herein, refers to any device, process, or service or combination thereof. A system may be implemented using components as hardware, software, firmware, a special-purpose device, or any combination thereof. A system may be integrated into a single device or it may be distributed over multiple devices. The various components of a system may be co-located or distributed. The system may be formed from other systems and components thereof. It should be understood that this and other arrangements described herein are set forth only as examples. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like. Such computing devices include one or more processors that read data from various entities such as memory or input components. Memory includes computer storage media in the form of volatile and/or nonvolatile memory. Memory may be removable, non-removable, or a combination thereof. Exemplary hardware devices include solid-state memory, hard drives, optical-disc drives, etc.

With reference to the autonomous discharge queue management system, embodiments described herein support automatic and autonomous discharge queue screening and prioritization. The autonomous discharge queue management system components refer to integrated components for autonomous discharge queue management. The integrated components refer to the hardware architecture and software framework that support data access, screening and prioritization functionality using the autonomous discharge queue management system. The hardware architecture refers to physical components and interrelationships thereof and the software framework refers to software providing functionality that can be implemented with hardware embodied on a device.

The end-to-end software-based autonomous discharge queue management system can operate within the autonomous discharge queue management system components to operate computer hardware to provide autonomous discharge queue management system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the autonomous discharge queue management system components can manage resources and provide services for the autonomous discharge queue management system functionality. Other variations and combinations of components and functionality are contemplated with embodiments of the present invention.

By way of example, the autonomous discharge queue management system can include an API library that includes specifications for routines, data structures, object classes, and variables may support the interaction between the hardware architecture of the device and the software framework of the autonomous discharge queue management system. These APIs include configuration specifications for the autonomous discharge queue management system such that the different components therein can communicate with each other in the autonomous discharge queue management system, as described herein.

The present invention might be described in the context of computer-executable instructions, such as program modules, being executed by a computer or other machine, such as a personal data assistant or other handheld device. Exemplary program modules comprise routines, programs, objects, components, and data structures and refer to code that perform particular tasks or implement particular abstract data types. The invention may be practiced in a variety of system configurations, including hand-held devices, consumer electronics, general-purpose computers, more specialty computing devices, etc. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 5, the computing environment 500 comprises a computing device in the form of control server 502. Exemplary components of control server 502 include a processing unit, internal system memory, and a suitable system bus for coupling various system components, including data store 504, with control server 502. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Control server 502 typically includes therein, or has access to, a variety of non-transitory computer-readable media. Computer-readable media can be any available media that might be accessed by control server 502, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 502. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Control server 502 might operate with network 506, using logical connections to one or more remote computers 508. Remote computers 508 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. Remote computers 508 might also be physically located in nontraditional medical care environments so that the entire healthcare community might be capable of integration on the network. Remote computers 508 might be personal computers, servers, routers, network PCs, peer devices, other common network nodes, or the like and might comprise some or all of the elements described above in relation to control server 502. The devices can be cell phones, personal digital assistants or other like devices.

Network 506 comprises one or more local area networks (LANs) and/or one or more wide area networks (WANs). Such networking environments are commonplace in offices, enterprise-wide computer networks, intranets, and the Internet. When utilized in a WAN networking environment, control server 502 might comprise a modem or other means for establishing communications over the WAN, such as the Internet. In such a networking environment, program modules or portions thereof might be stored in association with control server 502, data store 504, or any of remote computers 508. For example, various application programs may reside on the memory associated with any one or more of remote computers 508. It will be appreciated by those of ordinary skill in the art that the network connections shown are exemplary and other means of establishing a communications link between the computers (e.g., control server 502 and remote computers 508) might be utilized.

In operation, an organization might enter commands and information into control server 502 or convey the commands and information to the control server 502 via one or more of remote computers 508 through input devices, such as a keyboard, a microphone (e.g., voice inputs), a touch screen, a pointing device (commonly referred to as a mouse), a trackball, or a touch pad. Other input devices comprise satellite dishes, scanners, or the like. Commands and information might also be sent directly from a remote healthcare device to control server 502. In addition to a monitor, control server 502 and/or remote computers 508 might comprise other peripheral output devices, such as speakers and a printer.

Although many other internal components of control server 502 and remote computers 508 are not shown, such components and their interconnection are well known. Accordingly, additional details concerning the internal construction of control server 502 and the remote computers 508 are not further disclosed herein.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a computing environment in a medical facility; however the computing environment depicted here.in is merely exemplary. Components can be configured for performing novel aspects of embodiments, where the term “configured for” can refer to “programmed to” perform particular tasks or implement particular abstract data types using code. Further, while embodiments of the present invention may generally refer to the autonomous discharge queue management system and the schematics described herein, it is understood that the techniques described may be extended to other implementation contexts.

The present invention has been described in relation to particular embodiments, which are intended in all respects to be illustrative rather than restrictive. Further, the present invention is not limited to these embodiments, but variations and modifications may be made without departing from the scope of the present invention.

1. A system for implementing autonomous discharge queue management, the system comprising:
a hardware processor configured to perform a predefined set of basic operations in response to receiving a corresponding basic instruction selected from a predefined native instruction set of codes;
memory;
a screening component comprising:
a first set of machine codes selected from the native instruction set and configured to access a first data structure comprising admitted individuals having been admitted for a visit to an emergency department of a medical facility;
a second set of machine codes selected from the native instruction set and configured to determine, from the admitted individuals, retained individuals that have not been discharged from the emergency department and for which a discharge order has not been placed;
a third set of machine codes selected from the native instruction set and configured to access electronic medical records for the retained individuals to determine individuals with recorded vital signs having been recorded more than once; and
a fourth set of machine codes selected from the native instruction set and configured to determine eligible individuals by determining a vital sign stability;
a prioritization component comprising:
a fifth set of machine codes selected from the native instruction set and configured to sort eligible individuals based on length of stay;
a sixth set of machine codes selected from the native instruction set and configured to resolve sorting conflicts by designating a first resolution priority based on disability and by designating a second resolution priority based on age;
a seventh set of machine codes selected from the native instruction set and configured to initialize and populate one or more second data structures comprising a prioritized discharge queue of eligible individuals;
an eighth set of machine codes selected from the native instruction set and configured to generate an indication of discharge priority based on the prioritized discharge queue for delivery to at least one caregiver device in the emergency department; and
a queue manager component comprising:
a ninth set of machine codes selected from the native instruction set and configured to operate the screening and prioritization components to continuously update the prioritized discharge queue.

2. The system of claim 1, wherein the first data structure is a linear data structure.

3. The system of claim 1, wherein the fifth set of machine codes is additionally configured to sort in order of descending length of stay.

4. The system of claim 1, wherein the fifth set of machine codes is additionally configured to create tiered priorities based on an average length of stay.

5. The system of claim 1, wherein the indication of discharge priority is configured to cause a visual indicator to display on a caregiver device.

6. The system of claim 1, additionally comprising:
a medical parameter component comprising a tenth set of machine codes selected from the native instruction set and configured to make a stability determination in response to a request initiated by the fourth set of machine codes.

7. The system of claim 1, wherein the third set of machine codes is additionally configured to access the recorded vital signs though a real-time interface with a records database and determine whether a defined number of vital sign samples is present; and
wherein the fourth set of machine codes is additionally configured to access a latest set of vital sign samples and determine whether the latest set of vital sign samples falls within corresponding defined reference ranges.

8. A system for implementing autonomous discharge queue management, the system comprising:
a means for autonomously screening admitted individuals having been admitted for a visit to an emergency department of a medical facility to determine eligible individuals by determining a vital sign stability;
a means for autonomously prioritizing eligible individuals by sorting based on length of stay and resolving sorting conflicts by designating a first resolution priority based on disability and by designating a second resolution priority based on age;
a means for autonomously initializing and populating one or more data structures to create a prioritized discharge queue based on the means for screening and the means for prioritizing;
a means for operating the means for screening and means for prioritization to continuously update the prioritized discharge queue; and
a means for real-time delivery of the updated prioritized discharge queue to the emergency department.

9. The system of claim 8, wherein the one or more data structures are linear data structures.

10. The system of claim 8, wherein the sorting based on length of stay comprises sorting in order of descending length of stay.

11. The system of claim 8, wherein the sorting based on length of stay comprises sorting to create tiered priorities based on an average length of stay.

12. The system of claim 8, additionally comprising means for providing an indication of discharge priority to a caregiver device based on the prioritized discharge queue.

13. The system of claim 8, wherein the determining a vital sign stability comprises accessing a latest set of vital sign samples and determining whether the latest set of vital sign samples falls within corresponding defined reference ranges.

14. One or more computer storage media having computer-usable instructions that, when used by one or more computing devices, cause the one or more computing devices to perform a method for autonomous discharge queue management, the method comprising:
accessing a first data structure comprising admitted individuals having been admitted for a visit to an emergency department of a medical facility;
determining, from the admitted individuals, retained individuals that have not been discharged from the emergency department and for which a discharge order has not been placed;
accessing electronic medical records for the retained individuals to determine individuals with recorded vital signs having been recorded more than once;
determining eligible individuals by determining a vital sign stability;
sorting eligible individuals based on length of stay;
resolving sorting conflicts by designating a first resolution priority based on disability and by designating a second resolution priority based on age;
initializing and populating one or more second data structures comprising a prioritized discharge queue of eligible individuals;
generating an indication of discharge priority based on the prioritized discharge queue for delivery to at least one caregiver device in the emergency department;
continuously operating the screening and prioritization components to periodically update the prioritized discharge queue; and
providing an updated indication of discharge priority based on the updated prioritized discharge queue in real time.

15. The media of claim 14, wherein the first data structure is a linear data structure.

16. The media of claim 14, wherein the sorting based on length of stay comprises sorting in order of descending length of stay.

17. The media of claim 14, wherein the sorting based on length of stay comprises sorting to create tiered priorities based on an average length of stay.

18. The media of claim 14, wherein the indication of discharge priority is configured to cause a visual indicator to display on a caregiver device.

19. The media of claim 14, the method additionally comprising accessing the recorded vital signs though a real-time interface with a records database and determining whether a defined number of vital sign samples is present.

20. The media of claim 14, the method additionally comprising accessing a latest set of vital sign samples and determine whether the latest set of vital sign samples falls within corresponding defined reference ranges.
